(19) United States
(12) Patent Application Publication
(10) Pub. No.: US 2026/0160522 A1
(43) Pub. Date: Jun. 11, 2026

(54) Holster

(71) Applicant: Cliff Powers, Pampa, TX (US)

(72) Inventor: Cliff Powers, Pampa, TX (US)

(21) Appl. No.: 18/976,112

(22) Filed: Dec. 10, 2024

(51) Int. Cl. F41C 33/02; H01F 7/02

(52) U.S. Cl. CPC F41C 33/0209; H01F 7/0252

(57) ABSTRACT

A holster having a backplate and a pocket attached to a front of the backplate to form an area adapted to retain a firearm between the backplate and the pocket. A magnet providing a magnetic field emanating from the magnet and mounted to the backplate that is adapted to engage the firearm to aid in firearm retention in the holster. A user attachment device attached to the backplate adapted for affixing the holster to a user.

### BACKGROUND

The field of invention generally relates to firearm holsters. More specifically, the present invention relates to firearm holsters that have an additional firearm retention feature.

Traditionally leather holsters are form molded to provide a tight retention of the firearm as the primary retention in the holster. Over time the leather breaks down and the tightness of retention is reduced to a point that the holster retention is not effective any longer. As leather holsters age with use, they tend to get soft and lose the firearm retention capability of the holster.

It is an object of the present invention to provide a leather holster that does not lose the firearm retention capabilities after prolong use of the holster.

### SUMMARY OF THE INVENTION

A holster having a backplate and a pocket attached to a front of the backplate to form an area adapted to retain a firearm between the backplate and the pocket. A magnet providing a magnetic field emanating from the magnet and mounted to the backplate that is adapted to engage the firearm to aid in firearm retention in the holster. A user attachment device attached to the backplate adapted for affixing the holster to a user.

### BRIEF DESCRIPTION OF DRAWINGS

FIG. 1 is a perspective side view of a holster according to the present invention.

FIG. 2 is a perspective side view of a holster according to the present invention.

FIG. 3 is a perspective top view of a holster according to the present invention.

FIG. 4 is a perspective bottom view of a holster according to the present invention.

FIG. 5 is a perspective side view of backplate of a holster according to the present invention.

FIG. 6 is a perspective side view of backplate of a holster according to the present invention.

FIG. 7 is a perspective exploded side view of backplate of a holster according to the present invention.

FIG. 8 is a perspective view of backplate of a holster with a firearm according to the present invention.

FIG. 9 is a side of backplate of a holster with a firearm according to the present invention.

FIG. 10 is a perspective exploded view of backplate of a holster with a firearm according to the present invention.

### DETAILED DESCRIPTION

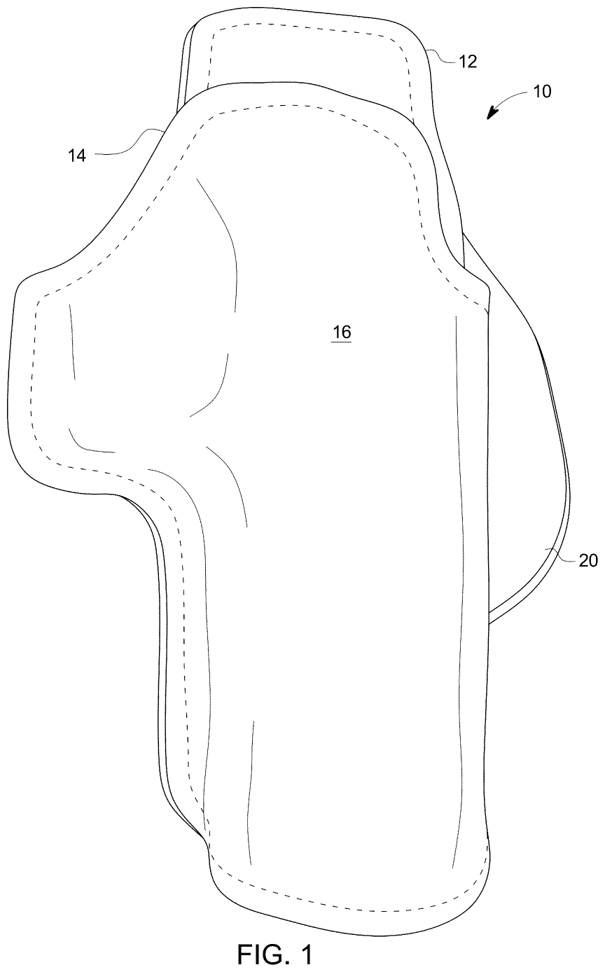

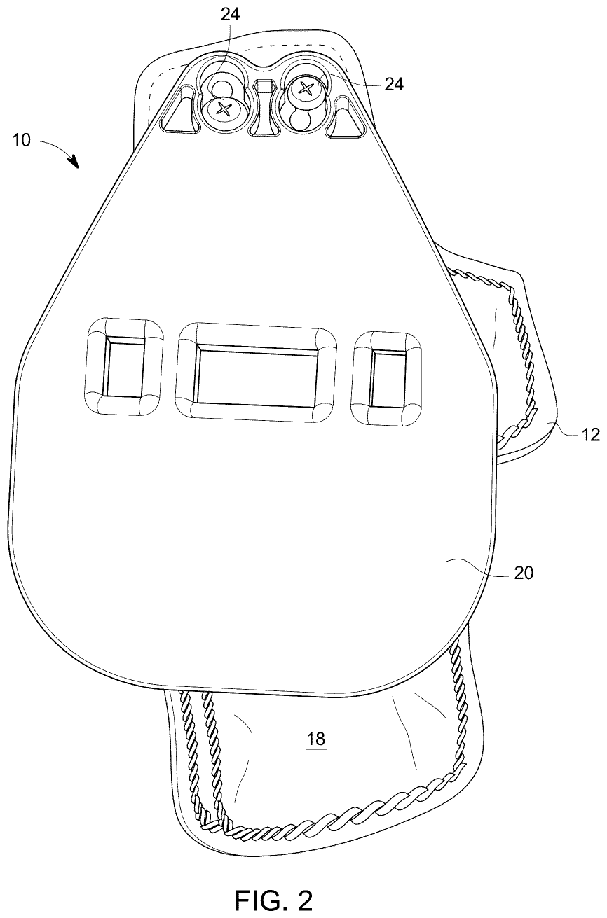

FIGS. 1-7 show a holster 10 or components of the holster 10 that includes an additional retention feature. The holster 10 includes a backplate 12 with a pocket 14 attached to the backplate 12. The pocket 14 includes an outside pocket face 16 that faces away from a user, as shown in FIG. 1. The backplate 12 includes an outside backplate face 18 that faces towards the user and is the rear of the backplate 12, as shown in FIG. 2. FIG. 2 also shows a paddle 20 attached to the backplate 12. The paddle 20 is attached using fasteners 24. The paddle 20 is a user attachment device designed to hook inside the waistband of the user to enable the holster 10 to be worn by the user. The paddle 20 is made of a durable material that does not wear out due to use. There are also other devices that can be mounted to the backplate 12 so that holster 10 can be worn by the user

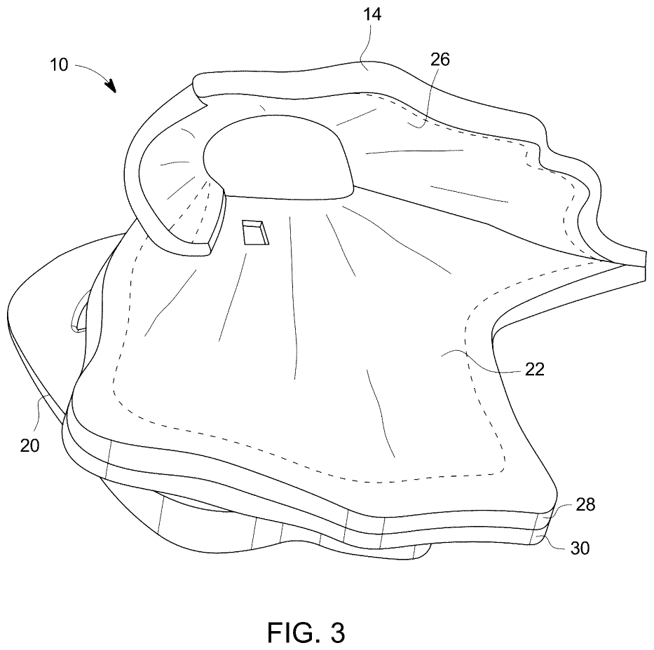

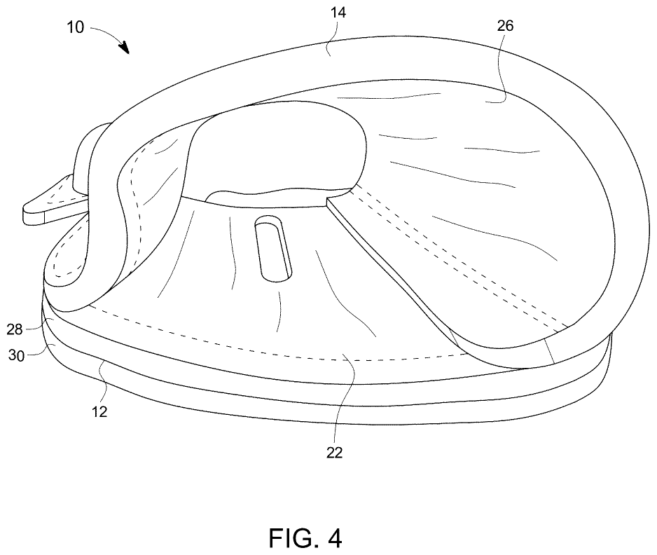

FIG. 3 shows a top view of the holster 10. The top of the holster 10 is designed to receive the firearm from above. FIG. 4 shows a bottom view of the holster 10. FIGS. 3-4 show features of the holster 10. FIGS. 3-4 show the pocket 14 having an inside pocket surface 26 and the backplate 12 having the inside backplate face 22. The inside backplate face 22 is the front of the backplate 12. The pocket 14 is formed fitted out of the material used in order to form fit the pocket 14 to the firearm. Preferable material is the use of leather for the main components of the holster 10. The pocket 14 is attached to backplate 12 so the firearm fits between the inside pocket surface 26 of the pocket 14 and the inside backplate face 22 of the backplate 12. FIGS. 3-4 show the backplate 12 having two separate layers of material to form the backplate 12. The first layer is an inside layer 28 that includes the inside backplate face 22 and the second layer is an outside layer 30 that includes the outside backplate face 18. The inside layer 28 includes a first mounting surface 32 on the opposite side of the inside backplate face 22. The outside layer 30 includes a second mounting surface 34 on the opposite side of the outside backplate face 18. The first mounting surface 32 and the second mounting surface 34 are mounted together to form the backplate 12.

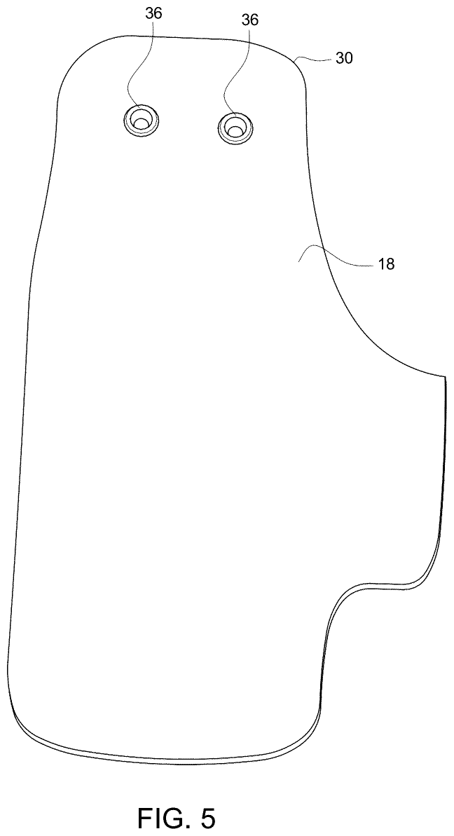

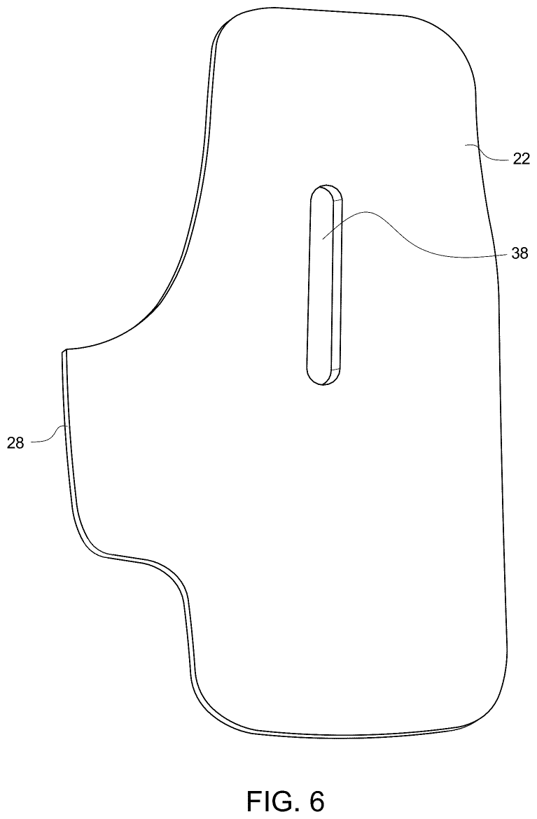

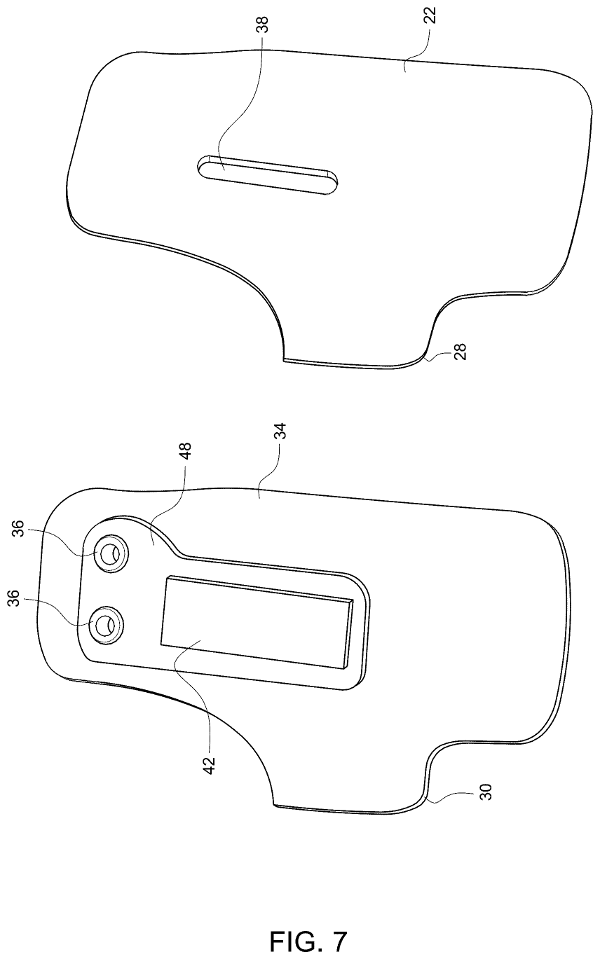

FIG. 5 shows the outside layer 30 with a view of the outside backplate face 18. The outside layer 30 includes two nut rivets 36 that are used to attach the paddle 20 to the outside backplate face 18 using fasteners 24 that screw into the nut rivets 36. FIG. 6 shows the inside layer 28 with a view of the inside backplate face 22. The inside layer 28 includes a magnet opening 38 that is a cutout hole. The magnet opening 38 is a through and through opening between the inside backplate face 22 and the first mounting surface 32. FIG. 7 shows the second mounting surface 34 of the outside layer 30 and the inside layer 28 with a view of the inside backplate face 22. FIG. 7 shows a metal plate 40 mounted to the second mounting surface 34 using the nut rivets 36, so that the metal plate 40 is riveted to the second mounting surface 34. A magnet 42 is attached to the metal plate 40 which aligns with the magnet opening 38 of the inside layer 28 when the inside layer 28 and the outside layer 30 are mounted together to sandwich the magnet 42 and the metal plate 40. The magnet opening 38 is a variable sized opening calculated to create specific strength retention of a firearm while in the holster 10. The metal plate 40 can be a stainless steel and the magnet 42 is preferably a 1/16″×2″ thin rare earth magnet. The magnet 42 provides a magnetic field that emanates from the magnet 42 and interacts with the firearm to retain the firearm in position. The magnet opening 38 can be cut larger for more magnetic force or smaller for less magnetic force. The relative size of the metal plate 40 aids in spreading the magnetic field. Increasing the size of the metal plate 10 increases the spread the magnetic field, while decreasing the size of the metal plate 40 decreases the spread the magnetic field.

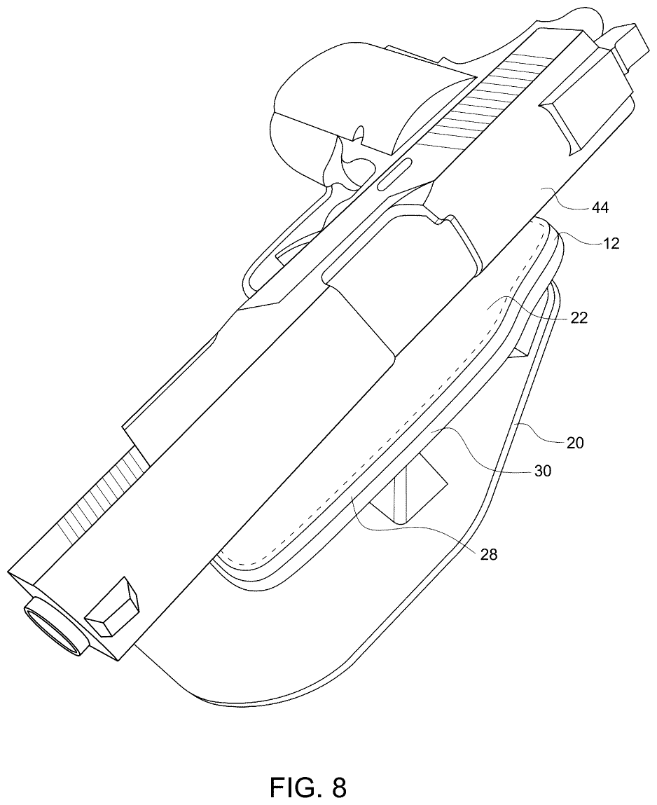

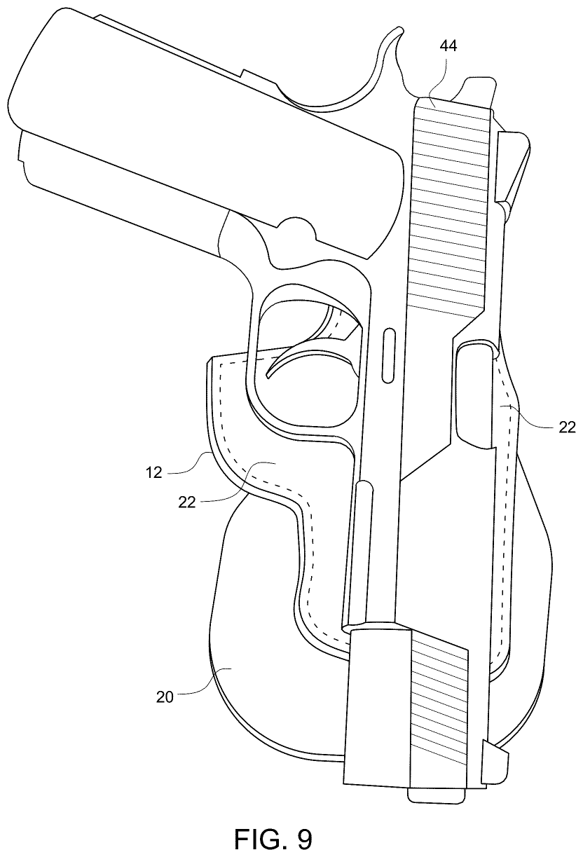

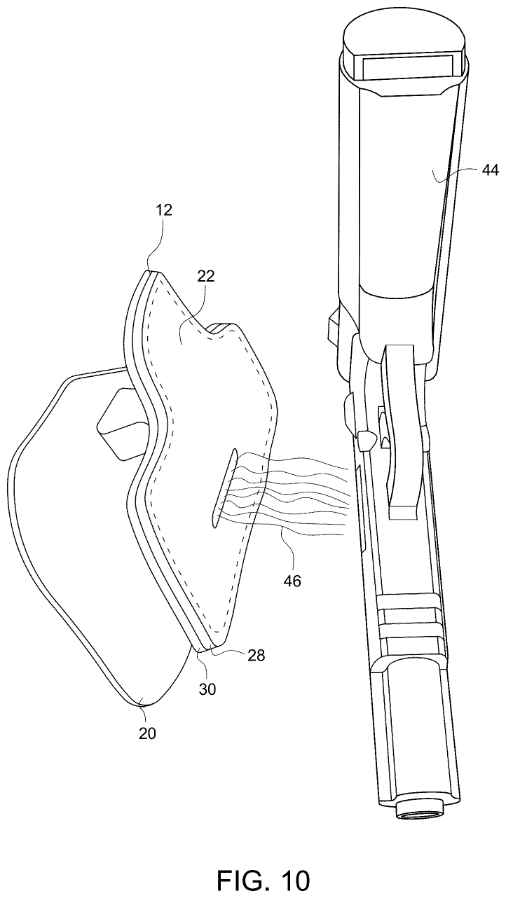

FIGS. 8-10 show the holster 10 without the pocket 14 to illustrate the interaction between a firearm and a magnetic field. FIG. 8 shows the firearm 44 against the backplate 12 to interact with the magnet and the magnetic field produced by the magnet. FIG. 9 shows the firearm 44 against the backplate 12 to illustrate the position of the firearm 44 in relation to the backplate 12. FIG. 10 shows the firearm 44 away from the backplate 12 to illustrate the interaction with the magnet and magnetic waves 46 of the magnetic field produced by the magnet. Magnets have been used in holsters to secure a firearm to the body of a user, but the present invention uses a magnet to secure the firearm in the holster not to the body of a user. The magnet is layered between inside layer and the outside layer of the backplate made of leather. The magnet opening is cut in the leather to allow use of the magnetic force of the magnet for retention while simultaneously reducing vertical pull on the firearm allowing it to be drawn with the ease of two fingers. The magnetic field is oriented perpendicular to the side of the firearm. This provides maximum holding force while at rest and minimum resistance when the firearm is drawn vertically and perpendicular to the holding force in the holster.

The combination of the rare earth magnet and stainless steel metal plate allows for the retention force to be spread out along the length of the firearm and provides rigidity in the holster that can be “reset” as the leather ages and becomes more pliable. The magnetic field of the plate and magnet provide tactical feedback to the user as the firearm is returned to the holster with a tangible “tug” as the firearm enters into the magnetic field of the holster. Here the magnetic force is used as a second way of retention along with the pocket and the backplate itself. The paddle does not loose retention over time for attachment to the user and the metal plate can be reshaped by the user as needed to maintain maximum retention.

While different embodiments of the invention have been described in detail herein, it will be appreciated by those skilled in the art that various modifications and alternatives to the embodiments could be developed in light of the overall teachings of the disclosure. Accordingly, the particular arrangements are illustrative only and are not limiting as to the scope of the invention that is to be given the full breadth of any and all equivalents thereof.

I claim:

1. A holster comprising:
a backplate;
a pocket attached to a front of said backplate to form an area adapted to retain a firearm between said backplate and said pocket;
a magnet providing a magnetic field emanating from said magnet and mounted to said backplate that is adapted to engage the firearm to aid in firearm retention in said holster;
an user attachment device attached to said backplate adapted for affixing said holster to a user.

2. The holster of claim 1, wherein said magnet is mounted within said backplate material and further includes a hole in the front of said backplate providing an open path between said magnet and the firearm.

3. The holster of claim 1, further including a metal plate under said magnet to enhance said magnetic field towards the firearm.

4. The holster of claim 2, further including a metal plate under said magnet to enhance said magnetic field towards the firearm.

5. The holster of claim 2, wherein said back plate has two materials that form said front of said backplate and a rear of said backplate and wherein said magnet is sandwiched between said two materials forming said backplate.

6. The holster of claim 4, wherein said back plate has two materials that form said front of said backplate and a rear of said backplate and wherein said magnet is sandwiched between said two materials forming said backplate.

7. The holster of claim 5, wherein said two materials forming said backplate are made of leather.

8. The holster of claim 7, wherein said two materials forming said backplate are made of leather.

9. The holster of claim 2, wherein varying hole size of said hole varies strength of said magnetic field.

10. The holster of claim 3, wherein said magnetic is of a rare earth magnet type and said metal plate is stainless steel.

11. The holster of claim 4, wherein said magnetic is of a rare earth magnet type and said metal plate is stainless steel.

12. The holster of claim 3, wherein varying metal plate size of said metal plate varies how said magnetic field is adapted to engage the firearm.

13. The holster of claim 4, wherein varying metal plate size of said metal plate varies how said magnetic field is adapted to engage the firearm.
